(19) United States
(12) Patent Application Publication
(10) Pub. No.: US 2006/0034093 A1
(43) Pub. Date: Feb. 16, 2006

(54) Heat resistant bulb sheild

(75) Inventor: Michael A. Strazzanti, Gates Mills, OH (US)

Correspondence Address: JEANNE E. LONGMUIR, 2836 CORYDON ROAD, CLEVELAND HEIGHTS, OH, 44118, US

(73) Assignee: Michael A. Strazzanti

(21) Appl. No.: 11/203,698

(22) Filed: Aug. 15, 2005

Related U.S. Application Data
(60) Provisional application No. 60/602,032, filed on Aug. 16, 2004.

(51) Int. Cl. B60Q 1/00

(52) U.S. Cl. 362/539

(57) ABSTRACT

An improved vehicle bulb shield having a heat resistant internal coating to reduce absorption of radiation invisible to the human eye, including infrared radiation, near infrared radiation and/or higher wavelength visible light. Additionally, the bulb shield disclosed may use high temperature thermoplastic or bake hardenable steel as the substrate material, in addition to conventional materials. Still further, the improved bulb shield may have a decorative or cosmetic mirror-like external surface finish which is obtained by the application of a coating of metal frit paint, or by conventional plating processes.

### CROSS-REFERENCE TO RELATED APPLICATIONS

The present application claims priority from U.S. Patent Application Ser. No. 60/602,032 filed Aug. 16, 2004, the entire subject matter of which is incorporated herein by reference.

### BACKGROUND OF THE INVENTION

1. Field of Invention

The present invention relates to vehicle bulb shield components and more specifically to a bulb shield which is coated with a substance that reduces the thermal impact of an adjacent high intensity light source such as a halogen bulb.

2. Background of the Related Art

U.S. Pat. No. 6,786,624 to Poorman discloses the use of a deterioration resistant Nickel Chromium Iron alloy composition in forming an automotive bulb shield. The disclosed design results in an increased temperature threshold of the bulb shield. An increase in the temperature threshold of bulb shields is desirable, since high intensity light sources for automotive lamps typically increase the bulb shield's temperature by up to 500-800 degrees Fahrenheit. Such high temperature conditions may have a negative impact on the performance of the component in accelerated life testing, as well as a negative impact on decorative finishes on the bulb shield, such as its nickel-chrome plating. It has been shown that when a bulb shield's temperature exceeds 700 degrees Fahrenheit or 315 degrees Celsius, a discoloration of the nickel-chrome finish occurs.

The source of light in automotive lamps is often a halogen or halogen-tungsten light bulb. Such light bulbs produce light through the heating of a filament. These bulbs can reach temperatures in excess of 1000° C.

Over the past 15 years the automotive lamp industry has moved to a head lamp design that employs a clear plastic lens, using optics only in the reflector portion of the head lamp housing assembly to direct light ahead of the vehicle. The head lamp housing assembly was also provided with a cosmetic nickel chrome finish, known in the industry as a ‘class A’ surface, having no scratches or blemishes. The effect of this cosmetic finish on the interior of the bulb shield was too reflective and necessitated an internal light absorbing coating.

The function of the bulb shield is to control the amount and direction of the radiation passing ahead of the vehicle. Bulb shield components were originally comprised of a cylindrical metal stamping having at least one section of the cylinder removed to allow light to be directed from the light source to the housing reflector. These stampings were comprised of stainless steel and coated in a black oxide process to reduce optical reflectance during operation of the light source. Bulb shields are necessary in vehicle headlamps to create a known boundary around the periphery of the light source from which light is permitted to reach the lamp or housing reflector, and is then reflected ahead of the vehicle. The creation of such a boundary enables calculation of the optical characteristics of the lamp, which must operate within acceptable light or photometric output levels as specified pursuant to federal safety standards.

Low reflectance in the visible spectrum is needed during operation of the head lamp to reduce any unwanted reflections inside the housing which may alter the optical prescription of the lamp, thereby making the light output of the lamp fall outside the federal regulated levels. Without a light absorbing internal bulb shield coating the visible radiation would reflect off of the interior of the bulb shield and cause “wild light.” Wild light is light reflected in an uncontrolled manner. If wild light is not absorbed by the interior of the bulb shield, it may be reflected forward from the lamp causing light output above acceptable photometric federally regulated levels. An additional complication with current vehicle head lamps was provided when the automotive industry standard became a brighter head lamp. Prior art head lamps were also provided with 12.6 Volt bulbs, but brighter lights having voltages as high as 14.3 V bulbs, for example, were desired, and created additional radiation within the head lamp housing.

As previously mentioned, up to 90% of the radiation emitted from a halogen bulb is in the infrared range of the electromagnetic spectrum. If absorbed by another material, the infrared radiation causes heat buildup in that substrate material. Due to the proximity of the bulb shield component to the light bulb, bulb shields must thus withstand high temperatures for extended periods of time. The close proximity of the bulb shield to the head lamp, which can be as close as 10-15 mm, causes the components to heat to temperatures in excess of 315° C. It is known in the science of electroplating that decorative nickel plating begins to lose brightness at 260° C. This reduction in brightness is due to the formation of an oxide film. At 315° C. the yellowish oxide film begins to thicken rapidly. These conditions are unacceptable due to cosmetic requirements.

The internal bulb shield coating used in the past was a heat resistant black paint, such as ‘Pot-Belly Black’. Although such coatings achieved head lamp functionality for a number of years, in recent models these paints have been shown to allow too much radiation absorption leading to an overheating condition of the bulb shield. The disadvantage and most noticeable effect of this condition is a discoloration or yellowing of the exterior nickel chrome finish. It is believed the discoloration is caused by chromium oxide formed during oxidation when the high temperature external chrome surface of the bulb shield is exposed to oxygen. One prior solution to the problem of discoloration in the exterior surface of the bulb shield was simply to move the bulb shield further from the bulb being shielded. Such solutions have the additional problem of altering the photometric output of the vehicle head lamp.

The present application provides an improved heat resistant bulb shield which absorbs the least amount of invisible radiation, resulting in reduced heat build-up in the bulb shield substrate, while maintaining acceptable photometric output levels from the bulb being shielded and the vehicle head lamp.

### BRIEF SUMMARY OF THE INVENTION

The present application discloses an improved vehicle bulb shield having a heat resistant internal coating. The improved bulb shield has an interior surface coated to reduce absorption of radiation invisible to the human eye, including infrared radiation, near infrared radiation and/or higher wavelength visible light. Certain embodiments of the bulb shield further disclose the use of novel substrate materials and novel external surface finishes. For example, the improved bulb shield may be formed in a manner common in the industry from metal materials such as stainless or cold rolled steel, or also of novel materials such as high temperature thermoplastic or dual phase steel.

Additionally, the improved bulb shield may have a decorative or cosmetic finish external surface which is metallic. Such finishes may be provided by conventional electroplating processes, for example, with a nickel-chrome plate, but also by other metallizing, electroless plating or by the application a coating of metal frit paint. The bulb shield external surface achieved is a cosmetic mirror-like metallic finish.

### BRIEF DESCRIPTION OF THE DRAWINGS

FIG. 1 illustrates a top view of a vehicle bulb shield having an internal heat resistant coating and external cosmetic finish coating of the present application;

FIG. 2 illustrates a side view of the vehicle bulb shield of FIG. 1;

FIG. 3 illustrates an end view of the interior of the vehicle bulb shield of FIG. 1;

FIG. 4 schematically illustrates a vehicle bulb shield of the present application within a vehicle head lamp housing;

FIG. 5 schematically illustrates the direction of radiation emission, absorption and reflection during operation of a vehicle head lamp having a bulb shield of the present application;

FIGS. 6 and 7 schematically illustrate the reflection and absorption of radiation by a vehicle bulb shield of the present application;

FIG. 8 is a graph illustrating the percentage of reflectance of prior art black coating materials at various wavelengths used on the internal surface of a bulb shield during operation; and

FIG. 9 is a graph illustrating the percentage of reflectance of the improved coating materials of the present application at various wavelengths used on the internal surface of a bulb shield during operation.

### DETAILED DESCRIPTION OF THE INVENTION

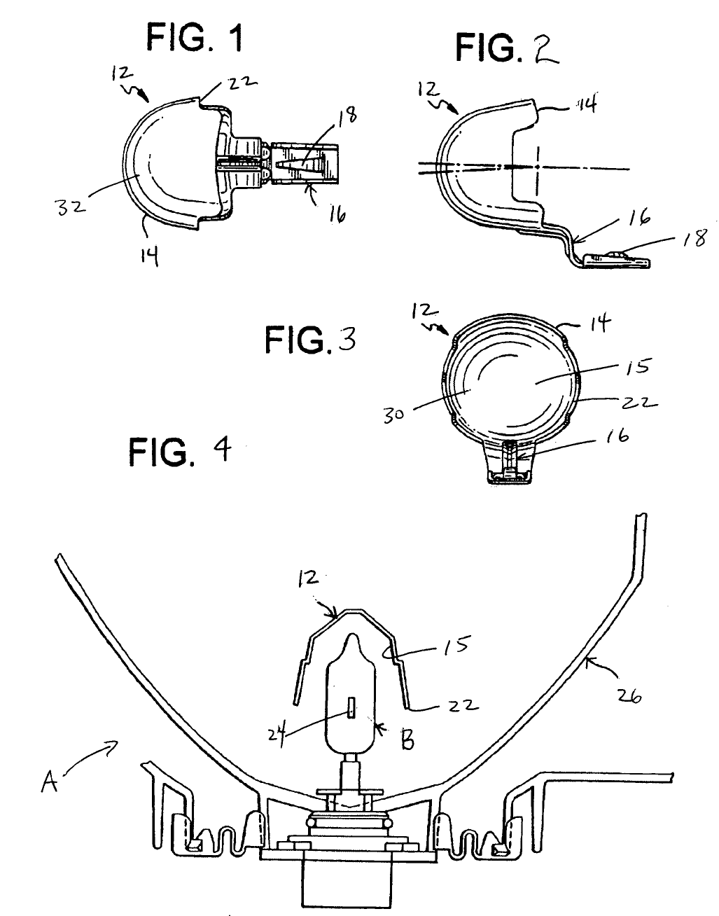

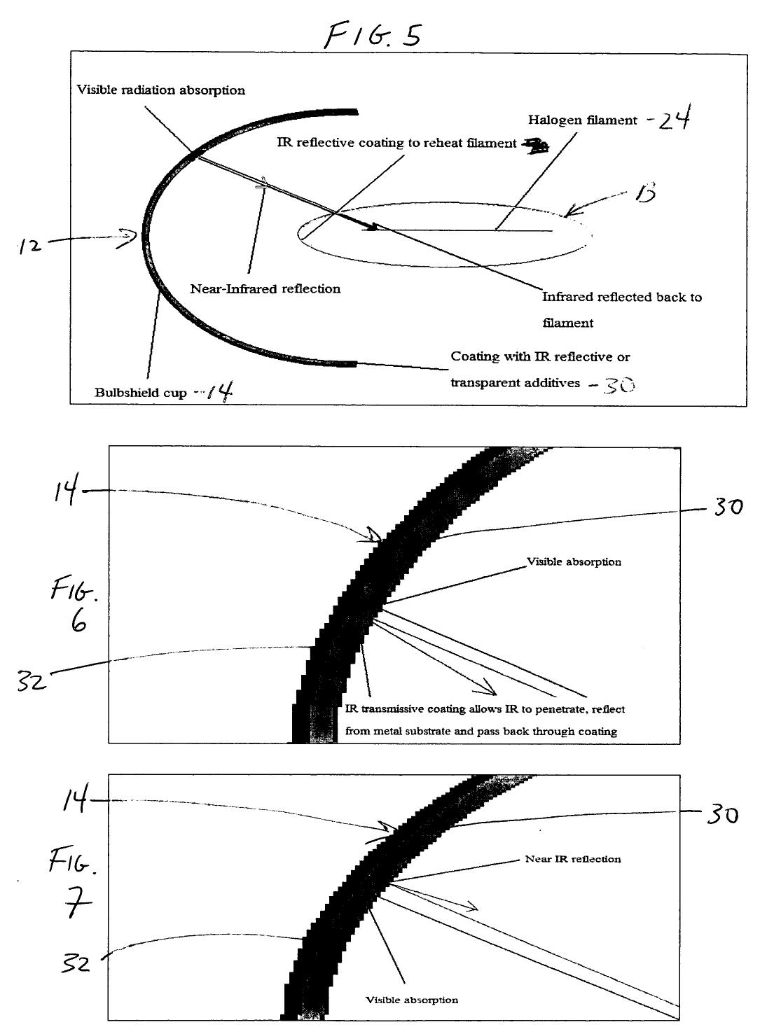

The present application provides an improved vehicle bulb shield of the type generally used in vehicle head lamp assemblies A to control photometric output. As shown in FIG. 4, the bulb shield 12 is placed in close proximity to a vehicle head lamp bulb B. FIGS. 1-3 illustrate a bulb shield 12, which is comprised of a cup portion 14 and a mounting leg 16. The mounting leg 16 is connected in some conventional fashion to the head lamp housing assembly A, for example, by a flange 18. The bulb shield 12 is oriented in the head lamp housing assembly A in a manner to place the bulb B adjacent to the interior 15 of the cup portion 14 of the bulb shield 12. The rim 22 of the cup portion 14 is generally formed with a specific profile to control what portion of the bulb filament 24 output reaches the head lamp reflector 26, and thus is reflected ahead of the vehicle (not shown), or to control the photometric output of the head lamp assembly A.

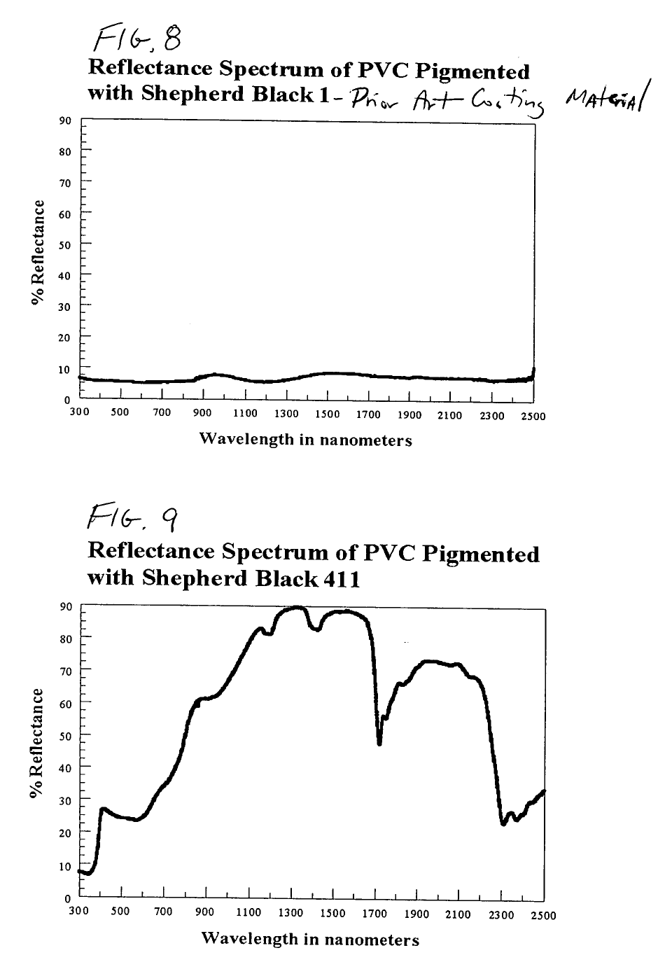

In the present application the improved bulb shield 12 includes an internal coating 30 of the cup portion 14. The internal or interior coating 30 is formulated to achieve absorption of radiation in the visible spectrum, so as not to alter the desired optical characteristics, or photometric output, of the head lamp through reflection, while at the same time reflecting radiation that is not visible to the human eye, in order to reduce the bulb shield temperature during operation of the vehicle head lamp or lamp. The paths of such reflections and absorptions are illustrated schematically in FIGS. 5, 6 and 7.

In the past, increased temperature levels in bulb shields 12 have resulted in undesired effects cosmetically or functionally in the bulb shield. The improved bulb shield having a heat resistant interior coating material 30 avoids such undesired effects by reducing the temperature levels in the bulb shield material or substrate. Because vehicle bulb shields are comprised of a variety of materials, both of their finishes and thicknesses, a specific temperature cannot be stated to allow every bulbshield to conform to allowable photometric output and performance characteristics. However, by experimentation it has been determined that bulb shield temperatures below approximately 650 degrees Farenheit are advisable to avoid oxidation of the external bulb shield surface or cosmetic finish 32 and other degradation of the bulb shield substrate.

The preferred internal coating material 30 is achieved by a combination of additives: one coating material addition reduces infrared absorption, thereby reducing substrate temperature buildup; another internal coating material additive used is a heat resistant paint, designed for long term exposure to high heat levels, so that a bulb shield capable of withstanding higher intensity light sources is achieved. An alternative to the addition of internal infrared reflective coatings is the use of an external ceramic coating provided on the bulb shield to achieve the desired purpose. For still further improved reductions in temperature and resistance to discoloration, both an improved internal coating and an external ceramic coating could be used. Thus, the possible combinations of coatings to obtain the desired results of the present application include: an internal coating of high heat resistant paint with a polished external ceramic coating; an internal coating of infrared reflective coating material (either alone or together with a high heat resistant paint) with a polished external ceramic coating; an internal coating of infrared reflective coating material (either alone or together with a high heat resistant paint) with a conventional external electroplated surface finish; or an internal ceramic paint material having low thermal conductivity with a conventional external electroplated surface finish.

Heat resistant coatings are currently used which are capable of surviving high heat environments. These coatings are also found on items such as ovens, gas grills, etc. Although these coatings survive the high temperature environment, they do not create a radiant heat or reflective barrier to keep bulb shield substrate temperatures down. FIG. 8 illustrates the low reflectance of such black prior art coating materials. One such high heat paint is the 900-SA series available from Flame Control Coatings located at 4120 Hyde Park Blvd., Niagara Falls, N.Y. 14302.

Coatings which reduce infrared absorption, or coatings which are infrared (IR) reflective, are typically customized for specific wavelengths of reflection in the desired infrared range by selecting solid particles that reflect electromagnetic radiation anywhere in the spectral region from about 700 nanometers to about 3000 nanometers. By adding pigment or particles which are reflective in the invisible wavelength spectrum to a coating or paint, it has been experimentally determined that a reduction of IR absorption by the paint is achieved, while minimizing reflection in the visible wavelength spectrum. Reductions in surface heating by additions of such pigments to the interior bulb shield coatings have been determined to be directly related to the increase in IR reflectance as a result of their addition. Specific pigments which have been determined to provide the desired reflectivity for heat resistance include Shepherd 411 and Shepherd 10C909, available from The Shepherd Color Company located in Cincinnati, Ohio 45246, and 10202 Eclipse Black, available from Ferro Corporation in Cleveland, Ohio 44105. FIG. 9 illustrates the higher reflectance obtained with such materials. It should be understood that additional components may be included in conventional coating materials previously used in connection with the interior coatings provided on vehicle bulb shields, and that such radiation reflective pigments and high heat tolerant materials are additions to such conventional coatings which are well known to those of ordinary skill in the art.

As up to 90% of the electromagnetic radiation emitted by a halogen bulb in a vehicle head lamp is IR, a substantial reduction in bulb shield substrate temperatures can be achieved by employing a coating comprised of such additives. Ideally, the interior coating of the bulb shield should only absorb that radiation, which if reflected, would place the vehicle head lamp outside the desired photometric output levels.

Another aspect of the vehicle bulb shield of the present application is the use of alternative substrate materials for the bulb shield, for example bake hardenable advanced high strength materials such as dual phase steel. Dual phase steels are steels comprised of ferrite and martensite. The chemistry and processing history of the steel produces a material with increased yield strength, due to pre-straining of the steel during the metalforming process, and subsequently baking the material to 100 to 250 degrees Celsius. The benefit of such bake hardenable steels in the bulb shield of the present application is that their yield strength increases as the head lamp bulb being shielded heats the bulb shield to temperatures in this range, thus producing the necessary heat to improve the bulb shields yield strength.

Specifically, vehicle bulb shields 12 of the present application may be stamped of bake hardenable steels such as dual phase steel, for example, DP700 available from Corus International, having an office at 475 N. Martingale Road, Suite 400, Schaumburg, Ill. The material is then painted or coated with the necessary and desired internal and external coatings previously described. The bulb shield 12 may then be baked to cure the paint or coatings, but such bake cycle is not required unless necessary, since the bulb shield is then heated to approximately 200-300 degrees Celsius during installation and use within the vehicle head lamp assembly A. While other steels generally lose strength at such high temperatures, the bake hardenable steels generally increase in strength up to a certain temperature. The use of an interior radiation reflective coating material of the type previously disclosed and described maintains the temperature of the bulb shield in a range which avoids over heating the substrate material beyond such temperatures, which are generally approximately 300 degrees Celsius. Increased resistance to vibration and improved service life are achieved with the elevated yield strength and tensile strength. The improved strength also allows bulb shields to be designed from thinner dual phase steel material, reducing cost and weight. The mechanical limitations of bulb shield designs often demand sacrifices in cosmetic and photometric design parameters. The use of dual phase and other bake hardenable advanced high strength steels improves the mechanics of a bulb shield 12 making such sacrifices unnecessary. Dual phase steel materials have also been shown to have improved formability characteristics over other steels with similar material strength properties, including Inconel alloys which are disclosed in Poorman for use in bulb shields.

Still another aspect of the improved bulb shield 12 of the present application is the use of a cosmetic metallic or mirror-like external surface finish 32 on the bulb shield. With the advent of head lamp designs that employ a transparent lens, the cosmetic appearance of bulb shields is become increasingly important. The vast majority of bulb shields made today are electroplated with a decorative combination of nickel and chrome to produce a highly lustrous mirror finish. The exterior of the cup portion 14 is of special criticality as it is highly visible in the headlamp assembly A. The mirrored appearance of decorative nickel chrome is defined by a term known as brightness. Brightness is high when the surface profile is smooth so as to reflect light evenly as opposed to a rough surface which would scatter the light and appear dull.

In the improved bulb shield 12 of the present application, a paint comprised of metal frit may be used as a ceramic coating on the external surface 32 of the bulb shield 12. When cured and polished and buffed the paint becomes lustrous and mirrored in a manner that appears similar to decorative nickel chrome. The coatings can be formulated with binders and other compounds which allow it to maintain integrity and cosmetic appearance to temperatures in excess of 1000° C. A source for one type of this paint known as Cerakote Chromex is produced by Caswell Inc., Lyons, N.Y. 14489. The application of the Chromex can take many forms; one possible sequence of operations is set forth below.

The painting of the Chromex can be completed in line with the painting of the interior 22 of the bulb shield cup portion 14. The painting of both substances can be performed with spray guns and other equipment known to those skilled in the art of painting and coating. The bulb shield 12 is then cured in an oven in accordance with the requirements of the two coatings. After curing the components are tumbled in a vibratory tumbler with a steel shot media. The burnishing action of the media serves to buff and polish the surface of the Chromex paint producing the desired finish. It has also been shown that such metal frit coatings may be susceptible to UV radiation degradation. Thus, it is also possible to use an additional UV reflective coating post treatment, meaning after the polishing process.

This process greatly reduces processing costs and complexity as compared to bulb shields produced with decorative nickel chrome plate. Bulb shields coated with these types of coatings are able to perform at temperatures where decorative nickel chrome would fail cosmetically. The use of metal frit paint also serves to reduce the prevalence of nickel chrome plating offering the industry an opportunity for a more environmentally responsible alternative. Still further external surface finishes may include metallizing or electroless plating.

While different embodiments of the invention have been described in detail herein, it will be appreciated by those skilled in the art that various modifications and alternatives to the embodiments could be developed in light of the overall teachings of the disclosure. Accordingly, the particular devices and arrangements are illustrative only and are not limiting as to the scope of the invention which is to be given the full breadth of any and all equivalents thereof.

I claim:

1. A vehicle bulb shield having an interior coating which substantially absorbs light visible to the eye and substantially reflects radiation outside this visible range, such as ultraviolet, infrared and near infrared, and which does not affect the photometric output of the bulb being shielded.

2. A vehicle bulb shield having an interior coating which reflects radiation in the range of approximately 700 nm and higher, and absorbs radiation in the range of approximately 400 m to 700 nm, and which does not affect the photometric output of the vehicle head lamp assembly within which the bulb shield is being used.

3. A vehicle bulb shield having an interior coating which reduces the temperature of the bulb shield material during operation of the bulb being shielded to a temperature of less than approximately 260 to 300 degrees Celcius.

4. The vehicle bulb shield of claims 1, 2 or 3 wherein the bulb shield is comprised of stainless steel.

5. The vehicle bulb shield of claims 1, 2 or 3 wherein the bulb shield is comprised of cold rolled steel.

6. The vehicle bulb shield of claims 1, 2 or 3 wherein the bulb shield is comprised of dual phase steel.

7. The vehicle bulb shield of claims 1, 2 or 3 wherein the bulb shield is comprised of a high temperature thermoplastic.

8. The vehicle bulb shield of claims 1, 2 or 3 having an exterior surface which is nickel-chrome plated.

9. The vehicle bulb shield of claims 1, 2 or 3 having an exterior surface which is coated with a ceramic or metal frit paint.

10. The vehicle bulb shield of claims 1, 2 or 3 wherein said bulb shield includes a drawn cup, an integral leg and a mounting flange extending from said integral leg.

11. The vehicle bulb shield of claims 1, 2 or 3 wherein said interior coating comprises a black pigment for absorbing radiation visible to the human eye and an infrared reflective pigment material.

12. The vehicle bulb shield of claims 11 wherein said infrared reflective pigment material in the interior coating of said bulb shield cup is Shepherd 411 coating material.

13. A vehicle bulb shield comprising a cup having a leg with a flange for attachment to a vehicle head lamp housing, said cup having an internal coating of heat resistant material and said cup having an external surface with a cosmetic mirror-like finish.

14. A vehicle bulb shield comprising a cup having a leg with a flange for attachment to a vehicle lamp housing, said cup having an external surface coating of metal frit paint to provide a cosmetic mirror-like finish.

15. A vehicle lighting metal part comprising,
a cup portion having an inner surface coated with a radiation absorbing coating material and an outer surface having a cosmetic metallic finish,
a connector portion rigidly connected to said cup portion, and
wherein at least said cup portion is formed of a bake hardenable high strength steel material.

16. The vehicle metal part of claim 15, wherein said bake hardenable high strength steel material is dual phase steel.

17. A vehicle bulb shield having an interior coating which substantially reflects radiation which is invisible to the human eye and reduces the temperature of the bulb shield material to temperatures less than approximately 260 degrees Celsius.

18. A vehicle bulb shield having a mirror-like metallic external surface finish and an interior coating which reflects radiation less visible to the human eye and reduces the temperature of the bulb shield material during operation of a vehicle head lamp assembly in which said bulb shield is being used to substantially eliminate discoloration of said external surface finish during operation of a vehicle head lamp assembly in which said bulb shield is used.
